(19) United States
(12) Patent Application Publication
(10) Pub. No.: US 2003/0006090 A1
(43) Pub. Date: Jan. 9, 2003

(54) Broadband noise-suppressing barrier

(76) Inventor: John Douglas Reed, Dayton, OH (US)

Correspondence Address: John Douglas Reed, 525 Ridgewood Avenue, Dayton, OH, 45409, US

(21) Appl. No.: 10/180,676

(22) Filed: Jun. 26, 2002

Related U.S. Application Data
(60) Provisional application No. 60/301,211, filed on Jun. 27, 2001.

(51) Int. Cl. B64F 1/26; G10K 11/00; E04H 17/00

(52) U.S. Cl. 181/210; 181/293; 181/290

(57) ABSTRACT

A broadband noise barrier includes Helmholtz-type resonator cavities. The barrier has a core section made up of one or more layers of cellular cavities of varying sizes sandwiched between a substantially planar face section placed toward a noise source, and an impermeable, substantially planar base section placed away from the noise source. The face section has apertures of specified sizes to permit disturbed air from the noise source to interact with the cavities in the core section. The variable cavity sizes permit resonant interactions with selected frequencies commonly associated with traffic noise, thus providing broadband acoustic absorption. Since the performance of the system derives from the resonator configuration rather than the constitutive properties of the materials used, the structure requires neither special materials, unconventional manufacturing processes, nor thick, heavy panel structures. The barrier may include additional layers of porous, sound-absorbing material to provide additional acoustic performance, and, in the case of a multiple-layer core section, have cavity walls between the various layers misaligned to minimize secondary modes of acoustic transmission. In addition, a cap-like edge section tailored to reduce the noise associated with diffracted sound waves can be added to a top or side edge of the barrier.

### BACKGROUND OF THE INVENTION

The present invention generally relates to broadband noise-suppressing barriers, and more particularly to structural acoustic panels based on Helmholtz-type resonators to reduce noise due to acoustic disturbances emanating from traffic routes over a wide range of acoustic frequencies.

Noise emanating from vehicular traffic flow on today's congested roadways is becoming increasingly burdensome to people who must live and work in areas adjacent to such traffic flow. Further complicating the noise problem is that rather than occupying a single discrete band within the acoustic spectrum, automobile, motorcycle, train and truck noise operates over a broad range of audible frequencies, hence the term “broadband” noise. Concern over excessive traffic noise has led government agencies to impose more stringent noise abatement requirements in the vicinity of major thoroughfares, especially when they are in close proximity to residential areas. Additional concerns relate to aesthetics, where roadside noise barriers must be as unobtrusive as possible, minimizing unsightly changes to the natural scenery. Even more important are cost issues, as most schemes to shield metropolitan and urban areas from the effects of traffic noise are undertaken by local, state, and federal governmental agencies, which, in turn, must make efficient use of scarce taxpayer resources. Accordingly, even technologically superior noise mitigation measures count for nothing if their implementation can't be achieved in an economically feasible fashion. This need to keep costs down also implicates durability, weight, and ease of fabrication considerations.

The complexity of characterizing traffic noise is such that attenuation of a primary, dominant mode of acoustic transmission is not enough, in and of itself, to bring acoustic noise levels behind these barriers to within an acceptable range. The most-cited requirement in noise barrier acoustic performance is its transmission loss (TL), which is the attenuation of noise that passes through the barrier on its way from the source to the listener. The range of TL requirements on noise barriers imposed by those jurisdictions that have such a requirement typically set the number to an A-weighted average of between 20 and 25 decibels (dB), where A-weighting is used to adjust the frequency network to account for nonlinearities in human hearing. TL is influenced by frequency of the sound and the weight of the barrier structure, and is often expressed empirically by formulas based on limp mass law, taking into consideration these two parameters. Generally, higher amounts of TL noise abatement can be achieved when the noise to be reduced is rich in high-frequency content, and when dense materials (for example, concrete or steel) are used in the barrier structure. Most barriers constructed from concrete or steel have more than adequate TL capability, due to their relatively high density.

Another oft-used requirement pertains to the addition of a sound absorbing material to help reduce the magnitude of the reflected sound. Most sound absorbing material is in the form of mats of glass or mineral fibers, or open-cell foam of a lightweight synthetic, such as polyurethane. These materials take advantage of their random porous structure to provide both loss of noise momentum as the waves expand, contract and change direction, and loss by heat generated due to friction caused by interstitial vibrating air. Such absorptive barriers are measured by a noise reduction coefficient (NRC), which is typically between 0.5 and 0.8 in most jurisdictions that impose such a requirement. The basic difference between TL and absorbent materials in noise abatement requirements is that the former is used when the intent is to reduce the transmission of sound between two different regions, while the latter is used when the intent is to reduce the sound levels within a particular region.

These figures of merit, while possessing some utility for single point performance of one mode of acoustic noise transmission, do not address the more subtle features of noise propagation. For example, TL predictions are often based on barrier walls in enclosed spaces, where the effects of diffraction and other secondary phenomena are negated. Such predictions also only consider the effects of normally incident waves, which do not model traffic flow on a roadway very well. The combined effect of secondary modes of transmission and the random incidence of waves on TL can produce markedly lower acoustic performance than the figures of merit indicate. Similarly, the NRC of absorptive barriers tend to display narrowband, peaky performance, where adequate reduction is achieved at or near the barrier's tuned frequency, but sharply diminished performance away from the designed resonant condition. Since typical traffic patterns produce sounds over a wide portion of the acoustic spectrum, such narrowband solutions offer only partial relief, at best.

With the melioration of direct (or “straight line”) propagation of noise made possible by the insertion of a barrier, hitherto secondary modes of propagation, such as diffraction, can become primary contributors to acoustic signature. In fact, diffraction is often the major contributor to noise where barriers have been installed. In essence, diffraction is the bending of a sound wave after it encounters a discontinuity in the medium of propagation. Diffraction makes it possible, for example, for a listener to hear a sound around the corner of a building, even without a straight-line path between the source and the listener, due to the corner of the building acting to reradiate the sound in various new directions. Diffraction as a noise source presents a two-fold difficulty: (1) it is more prevalent at the lower end of the frequency spectrum (due to the complex interaction of longer wavelengths with barrier edges), and (2) is more pronounced when the height of the barrier compared to the height of the source is diminished. Unfortunately, the combination of these two concerns is especially prevalent around highways, where noises emanating from trucks tend to be both low frequency (dominated by 100-125 Hz for engine exhaust), and often raised 10 to 15 feet above the ground (at the exhaust outlet).

The most common type of barrier in use for traffic-generated noise consists of either block masonry or concrete, with the concrete in either bulk slabs or pre-cast panels. Most are affixed to a conventional I-beam post, which in turn is secured to the ground through either a pedestal or a combination of conventional drilled shafts and spread footings. The block or concrete approach exploits the inherently dense nature of the material to achieve noise attenuation through TL. Such barriers are effective at providing high TL, and are inexpensive to fabricate; however, they are relatively ineffective at reducing noise levels over broad frequency bands, especially at the lower frequency end of the spectrum. In addition, they are heavy, which could limit their use on bridge structures, which often limit noise barrier weights to between 200 and 250 pounds per linear foot. Moreover, a barrier with high TL results in a high reflection of sound energy incident on the surface of the barrier back toward the source. This is important because the majority of barriers along a roadway have an equivalent barrier set up for traffic flow in the opposite direction. Such mirror image arrangements can, depending on the ratio of the barrier separation distance to height, give rise to highly undesirable multibounce phenomena that can actually increase noise levels in areas whose protection it was the purpose of the barriers to improve. One way to reduce multibounce problems is to add absorptive capability to conventional concrete barriers by including a relatively porous layer to the side facing the noise source. These porous layers, which often consist of concrete impregnated with wood chips or pulverized rubber, provide a measure of absorptive performance that is lacking in a solid concrete slab. Although concrete barriers with absorbers display improved NRC performance, they do so at significantly increased cost and barrier complexity, especially in situations where more comprehensive absorptive treatment is required to satisfy increasingly stringent performance requirements.

Block masonry is more amenable to accepting an absorptive layer of material than concrete, due generally to the presence of one or more hollow cores inside the block.

Difficulty still remains, however, because to take full advantage of the internal layer's sound-absorbing features, the normally high-TL block structure must permit the noise to work its way inside. While this can be accomplished through the addition of slots or apertures, or by controlling the porosity of the block, such an approach necessarily entails a higher manufacturing cost. Moreover, such an approach is susceptible to acoustic performance degradation over extended periods of environmental exposure, where moisture and contaminants (such as dust, litter, leaves or the like) can clog apertures and internal cavities.

Conventional metal barriers are also in current use as noise reduction panels along roads and highways. They are generally made from formed sheet metal, and their generally hollow panel configuration is more adapted to crafting sophisticated solutions to noise-related problems than a concrete slab. Nevertheless, they too suffer from many of the same, as well as additional, drawbacks. For example, to achieve requisite panel stiffness (such as to comply with wind loading criteria), they often must have corrugations added; this requirement can entail unique tooling and slow, labor-intensive processing, such as conventional break forming, that can significantly add to the cost. This, in turn, produces a new set of problems, in that increasing the stiffness of the barrier can lead to lower TL at resonant conditions where coincidence of free bending wave velocity through the panel with incident wave velocity through the air exists. In addition, rigid, stiff structural members can provide a very efficient conduit for certain secondary modes of propagation, such as flanking.

Other concepts, based on wood, brick, and even recycled rubber products have been attempted. They, too suffer from various limitations. For example, exposure to outdoor environments can adversely impact the long-term viability of wood-based barriers. To help preserve the wood, manufacturers often have to treat them with environmentally objectionable materials, such as chromated copper arsenate or volatile petroleum solvents, which can, through time, end up in the surrounding soil. In addition, wood-based barriers are neither broadband nor capable of providing attenuation of diffracted acoustic waves.

In an attempt to achieve noise reduction without having to resort to thick, heavy structures, various sound-absorbing devices based on Helmholtz resonators have been developed. In a Helmholtz resonator, an otherwise enclosed subsurface hollow cavity is maintained in fluid communication with the ambient air via one or more apertures in a top sheet facing the source of the disturbance. By appropriate choice of cavity dimensions and aperture size the device can be tuned to resonate at a preferred frequency. At this resonant condition, the acoustic impedance of the device approaches a minimum, thus permitting a maximum transfer of the noise power through the aperture, where viscous and sound wave radiation effects operate, and into the resonator cavity, where the inherent stiffness of the pressurized air can result in the molecular exchange of energy. These loss mechanisms within a Helmholtz resonator provide good noise attenuation over a narrow band of frequencies, and because the loss takes place inside hollow cavities, devices incorporating Helmholtz resonators can be effective even at relatively low frequencies without having to resort to unduly massive or unwieldy structures.

However, the application of traditional narrow-band Helmholtz resonators has only limited utility to structural panels to reduce roadway-generated noise. Automobile, motorcycle, and truck tire, exhaust, aerodynamic and engine noises present a wide variety of sound levels and frequencies over which the resonator must satisfactorily perform. In response, there have been numerous attempts at developing hybrid structures that employ a combination of material and configurational choices such that broadband noise attenuation is effected. Most of these have centered on coupling thick, heavy structural slabs (such as concrete) with porous absorbers, Helmholtz resonators, or both. Others have applied multiple-sized cavities to cylindrical duct-like structures, where extremely high stiffness and strength-to-weight of the structure are paramount, and issues of diffraction, flanking and related secondary modes of propagation germane to roadside noise barriers are not addressed. In addition, widely-varying sound pressure levels (SPL) induce a non-linear response in resonator cavities. Select environments produce such disparate SPL; for example, aircraft gas turbine inlet and exhaust ducts can exhibit tremendous variations in SPL, both along the axial length of the duct, as well as during different operating conditions. Resonator cavities formed into duct-like structures for such applications are capable of achieving suitable acoustic performance, if at all, only through a complex, expensive configuration where cavity material and dimensional characteristics are tailored to the specific SPL environment.

Consequently, based on a survey of the prior art, the inventor has discovered that unless a more holistic treatment of the acoustic noise propagation problem is undertaken, especially as it relates to both bandwidth broadening and secondary transmission phenomena, such as diffraction, flanking and multiple-reflection propagation, people dwelling in the shadow of such noise barriers will not be able to fully enjoy the benefits that noise reduction technology has to offer. While conventional approaches to confine or reduce traffic noise are currently being employed on and around roads, bridges, railways and airports, their effectiveness as noise attenuating structures is limited by one or more of the aforementioned problems and disadvantages. Thus, what is needed is a lightweight, low cost acoustic absorber that can combine the high TL levels of dense, massive noise barriers with the positive attributes of a traditional Helmholtz resonator to achieve broadband and secondary transmission attenuation capability.

### SUMMARY OF THE INVENTION

This need is met by the present invention wherein a noise barrier for use in traffic applications without the disadvantages of the prior art is described. The present invention is equally applicable to various forms of traffic, which includes both vehicular transportation associated with conventional mass transit applications (such as in roadway, railway and airport settings) as well as pedestrian noise-suppressing needs, such as pathways in commercial, professional and industrial settings, to reduce human exposure to objectionable or harmful noises.

In accordance with one embodiment of the present invention, a broadband noise-suppressing barrier for use adjacent traffic flow is disclosed. The barrier of the preferred embodiment is made up of a generally planar face section exposable to a source of acoustic disturbance, a base section spaced apart from the face section, and a central core section disposed between and coupled to both. Apertures in the face section permit fluid communication between the source of acoustic disturbance and the central core section, which is made up of numerous cavities configured as resonators. The sides of the cavities within the core section are further defined by a plurality of walls that extend transversely, or through the barrier thickness, arranged in a repeating pattern, while the top and bottom ends of each cavity terminate either at respective interlayer sheets (in multiple layer configurations), or the aforementioned face and base sections (in single layer configurations). Each of the cavities preferably acts independently as an acoustic energy absorption chamber, where the dimensions of the cavity and the area of the apertures making up fluid passageways into each cavity are two parameters that can be tailored to determine the frequency at which maximum absorption occurs. As long as the wavelength of the acoustic disturbance is large in comparison with the linear dimensions of the resonator cavities, cavity shape is not important. This is beneficial in that no undue fabrication constraints need be imposed in order to create exotic cavity shapes, thereby avoiding concomitant increases in barrier cost. Accordingly, cavities within the core section can be of conventional shape, and their sizes can be varied, with a plurality of each sized cavity tuned to resonate at a different, predetermined frequency generally coincident with a significant band within the spectrum of the source of acoustic disturbance. Moreover, since a barrier constructed in accordance to the present invention is not exposed to wide fluctuations in SPL (unlike the aforementioned duct-like structures found on aircraft gas turbine engine applications), the construction is not as sensitive to SPL-related non-linearities, thus allowing the cavities in the core section to be fabricated with conventional materials and methods.

To avoid acoustic “hot spots”, the different sized cavities of the preferred embodiment are interconnected, either end-to-end or laterally, to ensure even exposure to incident noise. A hot spot generally refers to a significant portion of the barrier surface area that contains no treatment within a particular noise frequency band such that little or no noise absorption is occurring within that band. Note that, unlike duct barriers, where the presence of high velocity air (or similar acoustic propagation medium) dictates that the oscillatory vibrations taking place within the apertures of the various cavities should have significant interaperture mixing to fully exploit the absorption offered by sequentially aligned cavities, static barriers placed a significant distance from the noise source (such as with a roadside barrier) tend to have all cavities bathed in the noise, thus doing away with complex vortex interaction as a way to avoid hot spot occurrence. This configuration permits the cavities tuned to various frequencies to be arranged in either a single or multiple layer panel, and also does away with the need to determine precise interaperture spacing to effect absorption due to such mixing. This approach to avoiding hot spots entails significant barrier simplification (and attendant reduction in fabrication cost and complexity), as well as increased tailorability to particular locations and their space and volume requirements.

It will be appreciated by those skilled in the art that although the barrier containing the resonator cavities is configured to achieve maximum sound absorption at frequencies that coincide with dominant traffic noise sources, such as tires, engines, exhausts, and vehicle-generated aerodynamic effects, the description of the present barrier renders it applicable to any multifrequency noise source, and through proper choice of cavity dimension and aperture area, can be tuned accordingly. Thus, the configuration can be adapted to other outdoor environments (such as runways and railways, where weatherability and durability may be important considerations), indoor office and professional environments (including areas adjacent automated data processing equipment, copiers or the like, where aesthetics, portability and integration into limited spaces are applicable) or industrial environments (where the barrier needs to be resistant to manufacturing and processing equipment that can liberate byproducts, particulate matter and harsh chemicals).

Optionally, the apertures extend through the face section in an upwardly-sloping path so that moisture (generally in the form of rain or snow) doesn't collect in the core section cavities. An additional option could have the core section subdivided into a series of stacked (through-the-thickness) layers. Individual layers within the stack, save that adjacent the base section, could be separated by a perforate interlayer sheet to facilitate fluid communication between successive layers so that the acoustic disturbance would pass through the first layer prior to entry into the second layer, which would precede entry into the third layer, and so on until it reaches the end of the last layer, which terminates at the base section. To ensure optimum performance, the first layer encountered by the acoustic disturbance is tuned to the lowest frequency of interest, with each successive layer made up of cavities tuned to higher and higher frequencies. If this order is not followed, then the higher frequency cavities can inadvertently act as filters for the lower frequency noise, reflecting it back without any absorption. In addition, rather than having continuous cavity walls in the core that extend all the way between the face and base sections, the stacked layer approach of the present invention can have misaligned, discontinuous wall segments to reduce transverse, or through-the-thickness, wall continuity, which has the effect of reducing flanking and related acoustic propagation phenomena. Flanking, in a general sense, is that noise that propagates to an adjacent or remote space through non-direct paths, often in the form of rigid support or peripheral structure. In this context, transmission through a wall or similar partition is not included as flanking, whereas transmission through the underlying support structure (such as along a structural beam) is. This reduction in wall continuity can produce marked reductions in acoustic flanking, as structural discontinuities effectively dampen out the flanking wave. For example, by having the wall of one layer terminate predominantly on the relatively flexible unsupported part of the interlayer sheet (and consequently, only minimally terminated on an underlying, successive wall), the through-the-thickness, or front-to-back, flanking path becomes at least partially decoupled.

In the alternate to the stacked configuration, the core section can comprise a single layer of resonator cavities such that the top and bottom ends of each cavity within the core section terminate at the face and base sections respectively. In this configuration, the cavities can be grouped side-by-side to provide more efficient packing of the plurality of resonator cavities. As previously mentioned, this localized grouping does not adversely effect barrier hot spot performance for roadside barriers, where geometric spreading of the source of the acoustic disturbance ensures that the entire surface of the barrier will be exposed to the entire spectrum of sound. In either the stacked or single layer alternatives, at least one layer of porous sound absorbing material can be placed within at least a portion of the cavities to provide frictional and momentum loss to the oscillating sound. In such circumstances, care must be maintained to account for the effective change in cavity volume brought about by the addition of the absorbing material, so that proper frequency tuning in the cavity is maintained.

The top of the barrier wall can also be fitted with a three-dimensional diffraction attenuator cap, of which generally trapezoidal or curvilinear shapes (when viewed edgewise) are specific examples. Generally, when an acoustic wave encounters a discontinuity in impedance to its flow in going from a first medium into a second, it sheds energy above that which it needs to continue propagation through that second medium.

The energy being shed is re-radiated at the boundary between the two mediums, thus resulting in the boundary becoming not just a new noise source, but an omnidirectional one at that, spreading sound into areas that were previously within an acoustic shadow boundary. The advantage to the diffraction cap is that for most frequency ranges of interest, an absorptive edgepiece need only cover the surface of the barrier within about one wavelength of the top of the barrier for the lowest frequency encountered to be effective as a diffraction wave attenuation device. For noise sources in the 500 Hz range, this means that a diffraction cap of approximately 2 feet in height will suffice, with higher frequencies requiring even less space. The additional height attributed to the diffraction cap can be further minimized by configuring the cap to straddle the top of the barrier with the cap's absorptive cavities placed in downward-extending side members placed adjacent the uppermost portion of the barrier face and base section walls. With typical barriers being between 10 and 15 feet tall, the addition of the diffraction cap, even tailored to some of the lower highway frequencies, provides valuable attenuation without a significant increase in barrier real estate, especially height. The insertion of such a device on top of the already absorptive barrier can improve overall acoustic performance by reducing the tendency of the barrier edge to function as the aforementioned new noise source. Proper shaping of the diffraction cap can further improve its performance; by gently curving or faceting the diffraction cap, that portion of the wave interacting with the cap can be coaxed into a more coupled relationship with the absorptive elements contained therein.

According to another embodiment of the present invention, a broadband noise-suppressing barrier configured for use along a roadway is disclosed. The structural relationship between the face section, core section, and base section of this embodiment is similar to that of the previous embodiment. Cars, trucks, and motorcycles traveling on a roadway generate noise across a significant portion of the acoustic spectrum from about 100 Hz to 4000 Hz. Of that noise, significant portions are found in a few discrete bands for exhaust, engine, tire, and aerodynamic noise caused by the vehicle profile. The cavities of the barrier can be tuned to a plurality of the more prominent noise source frequencies.

According to another embodiment of the present invention, a broadband noise-suppressing panel configured for use along a traffic route is disclosed. The construction of the face, core and base sections, as well as the acoustic properties, are similar to that of the previous embodiments. Unique to this embodiment is that the panel can be attached to a surface adjacent a traffic route, for example a high TL structural barrier (such as an existing concrete slab supported between steel or concrete 1-beams) to effect additional acoustic performance. This situation is ideal as a retrofit, in that it can provide a low cost solution to traffic noise problems where relatively low acoustic performance barrier infrastructure already exists. Accordingly, the noise-suppressing panel includes attachment features that would permit the existing structure to be placed behind the panel's base section, thereby providing acoustic attenuation capability in a visually and volumetrically unobtrusive package. These attachment features may be further adapted (such as through tailored compliance/stiffness) to minimize flanking, thereby ensuring that any degradation of structureborne TL due to wave trace coincidence is avoided, as the coupling of the stiff, lightweight resonator cavity panel to a traditional limp mass rear panel can be effected by vibration-isolating mounts. This embodiment has the advantage of leaving in place an initial investment in existing structural barriers while simultaneously improving their acoustic performance through the addition of broadband, flanking and diffraction attenuation features at only a fraction of the cost of replacing the entire existing barrier. As with the previous embodiments, a single or multilayer core section may be employed, and acoustic absorption material may be added for additional attenuation. In the present embodiment, the acoustic absorption material may be added in the cavities of the acoustic panel member, between the acoustic panel member and the rigid structural backing member, or both. A water-impervious boundary may be used to cover any acoustic absorption material that would be otherwise directly exposed to rain, snow or the like.

According to another embodiment of the present invention, a method of reducing noise adjacent a traffic route is disclosed. The method comprises the steps of configuring a broadband noise barrier to be responsive to a plurality of predetermined noise source frequencies, arranging the noise barrier alongside at least a portion of the traffic route, exposing the noise barrier to the noise source, introducing the noise source into a core section of the noise barrier and absorbing at least a portion of the noise corresponding to the plurality of predetermined noise source frequencies with a plurality of resonator cavities disposed within the barrier. The noise barrier includes three main sections: a face section, a core section, and a base section. The face section is exposable to the noise source and includes a plurality of apertures therethrough. The base section is spaced apart from the face section in a transverse direction, and is preferably parallel to the face section. The core section is disposed between and coupled to both the face section and the base section such that at least a portion of the core section is in fluid communication with the noise source. The core section is made up of numerous resonator cavities of varying resonant frequency acoustic absorption characteristics tuned such that the cavities are preferably responsive to the plurality of predetermined frequencies of the noise source.

Optionally, the plurality of discrete cavities can be further defined by a plurality of cavity sets such that the physical dimensions each of the plurality of Helmholtz resonator cavities defined within a particular cavity set are similar, and that the physical dimensions of the cavities within a particular cavity set are different than those of the cavities within the remaining cavity sets. The core section may further comprise a plurality of layers in a stacked relationship such that each set of the plurality of cavity sets is disposed solely within a single layer, and at least one perforate interlayer sheet disposed between adjacent layers such that the adjacent layers are in fluid communication with one another. In the stacked arrangement, the core section walls, which extend in a transverse direction between the face section and base section, can be partially decoupled from one another such that flanking and related structureborne acoustic propagation is reduced. Another option to the step of introducing the noise source into the core section further is to configure the layers such that the layer closest to the face section is capable of absorbing the lowest frequency acoustic energy, and that each successive layer is tuned to absorb higher noise source frequencies than the preceding layer. As with the previous embodiments, at least a portion of the cavities may include sound absorbing material disposed therein. Moreover, the individual cavities from the plurality of cavities are interspersed among one another to define an efficient, closely packed configuration.

### BRIEF DESCRIPTION OF THE DRAWINGS

The following detailed description of the preferred embodiments of the present invention can be best understood when read in conjunction with the following drawings, where like structure is indicated with like reference numerals and in which:

FIG. 1 is a perspective view of a representative barrier placed adjacent a roadway as practiced by the prior art;

FIG. 2 is a representation of the predominant modes of acoustic propagation from vehicular traffic sources;

FIG. 3A is a single Helmholtz cavity resonator showing the cavity and aperture;

FIG. 3B is a cutaway along line A-A of FIG. 3A, showing the oscillatory vibration of air through an aperture;

FIG. 4A is a partial cutaway perspective view of a noise barrier section according to one aspect of the present invention, depicting an array of multiple-sized Helmholtz resonator cavities;

FIG. 4B is an edgewise cutaway view of the barrier of FIG. 4A, showing the apertures in an optional upward-sloping configuration;

FIG. 5A is an exploded perspective view of a noise barrier section according to an aspect of the present invention, revealing a face section, a single layer core section, and a base section;

FIG. 5B shows the addition of a layer of sound absorbing material to a part of the core section of the noise barrier section of FIG. 5A;

FIG. 6A is an exploded perspective view of a variation of the noise barrier section of FIG. 5A, employing a multilayer core section;

FIG. 6B shows the addition of a layer of sound absorbing material to a part of the multilayer core section of the noise barrier section of FIG. 6A;

FIG. 6C shows an edge view of an alternate embodiment of the internal structure of a multi-layer noise barrier of the present invention, showing intentional interlayer misalignment of the cavities;

FIG. 6D shows a perspective view of the misaligned cavities of FIG. 6C;

FIG. 7A is a perspective view of the embodiment of FIG. 4A, including a diffraction cap placed along the barrier upper edge;

FIG. 7B is an enlarged edgewise view of a preferred embodiment of the top cap-like section illustrating the multisided diffraction attenuating features; and

FIG. 8 is an exploded perspective view of another embodiment, combining the noise suppressing wall section panel connected to an existing, conventional structural barrier with a conventional attachment.

### DETAILED DESCRIPTION OF THE PREFERRED EMBODIMENTS

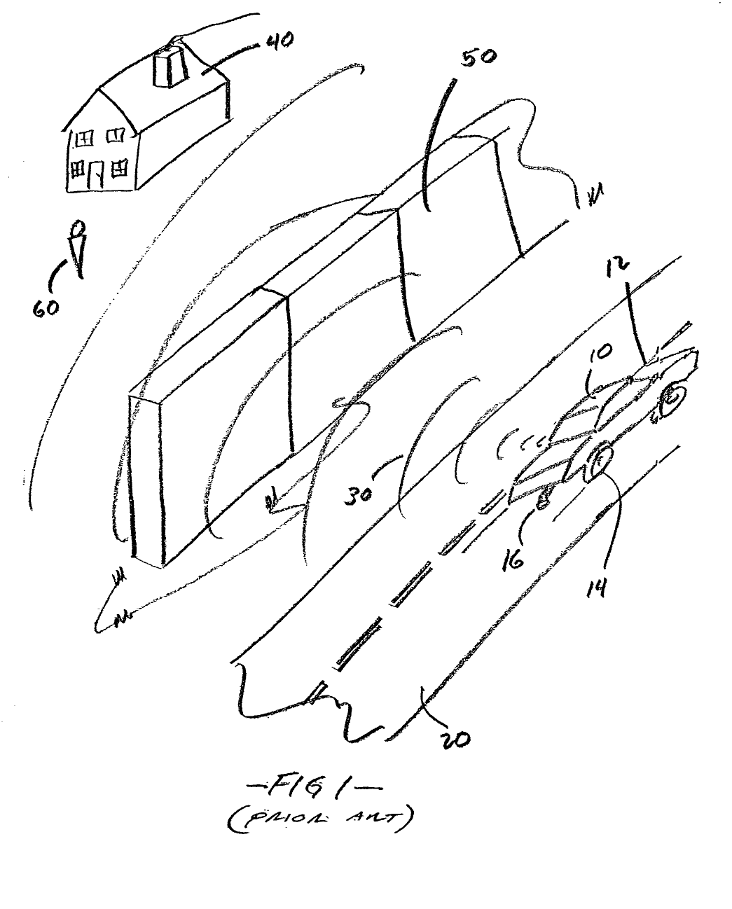

Referring first to FIG. 1, a typical highway scenario is shown. Vehicles 10 travel along roadway 20, producing acoustic disturbances 30 that radiate outward to, among other places, houses 40 and related dwellings. Vehicles 10 include numerous sources of acoustic disturbance 30, including motors 12, tires 14 and exhaust 16. The insertion of prior art barriers 50 between the sources and receivers 60 acts to reduce exposure to unwanted visual and acoustic phenomena. While these prior art barriers 50 provide some measure of noise reduction, their relative insensitivity to the broad spectrum of noise emanating from a highway leads to a compromised acoustic environment for receivers 60 on the other side of barrier 50. It will also be appreciated by those skilled in the art that the barriers of the present invention may be applied to other traffic routes than automobile highways. For example, other vehicular routes, such as rail, marine and aircraft environments, as well as pedestrian routes in office, commercial and industrial settings, could have their acoustic environments improved by application of the broadband barriers of the present invention.

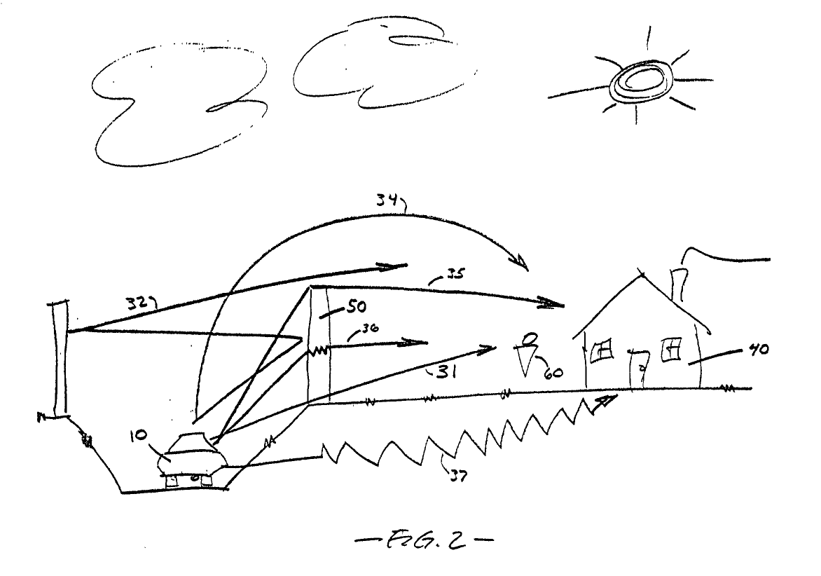

Referring next to FIG. 2, the dominant modes of acoustic propagation for the scenario of FIG. 1 is shown. A direct (or line-of-sight) mode 31 is that which passes in an essentially straight path from vehicle 10 to receiver 60, and can include passage through an acoustic discontinuity, such as barrier 50. Note that when barrier 50 is a high TL medium, such as dense concrete panels, the noise reaching the receiver 60 from the line-of-sight mode 31 is reduced. Multibounce mode 32 arises out of the mirror image arrangement of parallel barriers 50. A high TL barrier 50 is not an absorber, but merely an efficient reflector of acoustic energy. As such, multibounce mode 32 stems from the relatively lossless reflection of the noise until it escapes the confines of the mirror image container. Absorptive treatment can be added to attenuate each bounce; however, absent broadband treatment, the unattentuated frequencies not absorbed will eventually escape to the dwelling 40 side of barrier 50. Accordingly, multibounce mode 32 can actually be made worse by the containment effect of the mirror image reflective barriers. Atmospheric (i.e., thermal and wind effects) 34 can reroute energy otherwise destined for space into what was hitherto considered to be within the acoustic shadow zone, thus propagating downward toward the receiver 60. Diffraction 35, where an acoustic discontinuity acts as a new sound source, redirects the sound isotropically, especially if the wavelength is long. Flanking 36 is a structureborne mode, and propagates through rigid structural components (such as I-beams, connecting rods or the like), especially at lower frequency noise signals. Ground effects 37, especially where the ground is a softer medium, can give rise to interference patterns that can increase noise levels at certain frequencies.

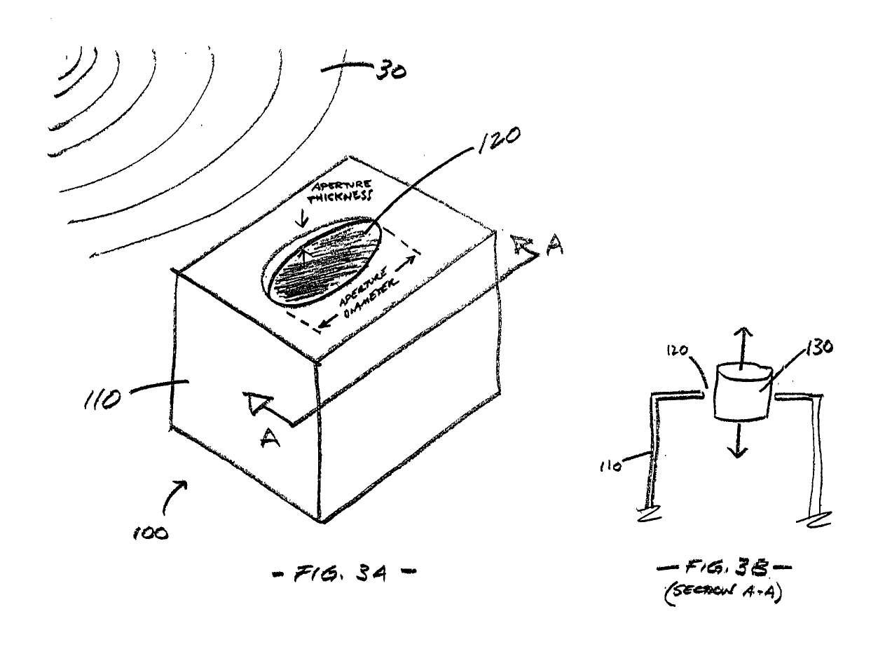

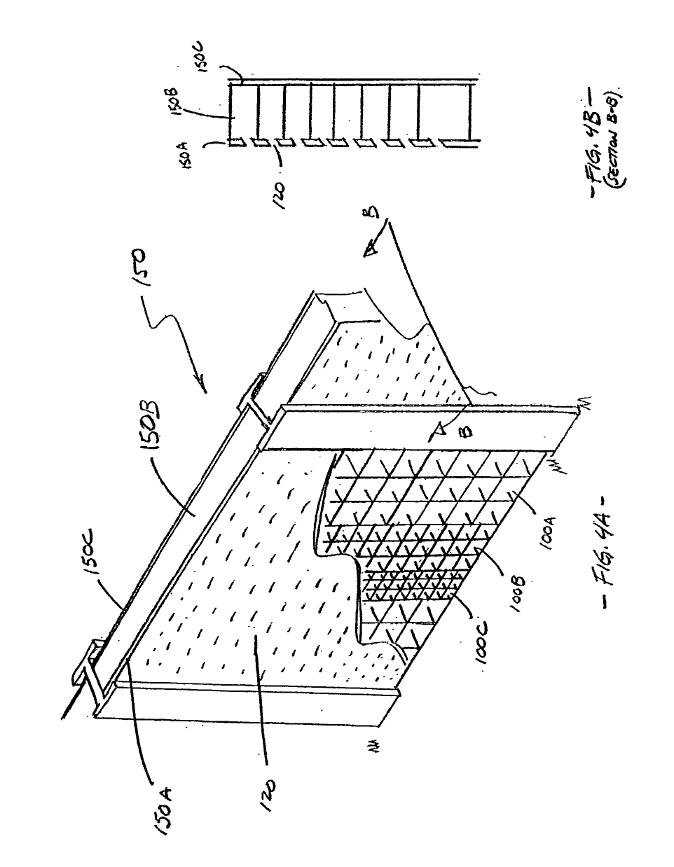

Referring now to FIGS. 3A and 3B, the details of a Helmholtz cavity 100, with body 110 and aperture 120, are shown. As previously mentioned, face thickness, aperture size (either collectively or individually) and cavity dimensions are all adjustable parameters used to create a device that will resonate, or absorb a maximum amount of acoustic energy, at a particular frequency. To perform as a resonator, each cavity 100 responds to the acoustic disturbance 30, where the one or more apertures 120 serve as fluid communication paths between the ambient environment and the internal portion defined by body 110. In the present invention, each cavity functions in a discrete way, in that the attenuation taking place within each cavity is substantially independent of what is occurring in neighboring cavities. As used in conjunction with the present disclosure, the term “substantially” refers to an arrangement of elements or features that, while in theory would be expected to exhibit exact correspondence or behavior, may in practice embody something slightly less than exact. In the present context, that the presence of one or more cavities within the present invention that may share a common aperture or set of apertures (for example, in a stacked cavity arrangement) does not detract from the instant definition of discrete cavity, as acoustic disturbances can pass from the low frequency absorbing more proximal layers to the high frequency absorbing more distal layers, losing successively higher frequency energy along the way. Helmholtz resonator cavity 100 attenuates sound through viscous, frictional and radiative forces acting on a periodic wave at the aperture 120 of the cavity. At its resonant condition, the impedance of the cavity 100 to incident acoustic disturbance 30 is at a minimum, thus permitting maximum power transfer to the cavity 100 from the disturbance 30. This maximum transfer of power coincides with the oscillatory movement of a generally cylindrical shaped slug 130 of air through aperture 120, as shown particularly in FIG. 3B. Mathematically, the resonant condition is expressed as:

$${f}_{0} = \frac{c}{2 π} \sqrt{\frac{A}{{l}^{′} V}}$$

where f₀ is the resonant frequency, c is the speed of sound in the medium of propagation (usually air), A is the area of the aperture, l′ is the effective length, or thickness, of the aperture, and V is the volume of the cavity. Note that an approximation for the effective length for most cases of interest is:

$${l}^{′} = l + \frac{16 r}{3 π}$$

where l is the true thickness of the aperture, and r is the aperture radius. It is noted that Helmholtz resonators configured as a barrier can also contribute to TL, of which numerous empirical expressions have been derived. Thus, it is possible for a device made up of a plurality of Helmholtz resonator cavities 100 of the present invention to satisfy stringent TL requirements without the addition of a thick slab of concrete or block by appropriate choice of resonator body 110 dimensions and aperture 120 area.

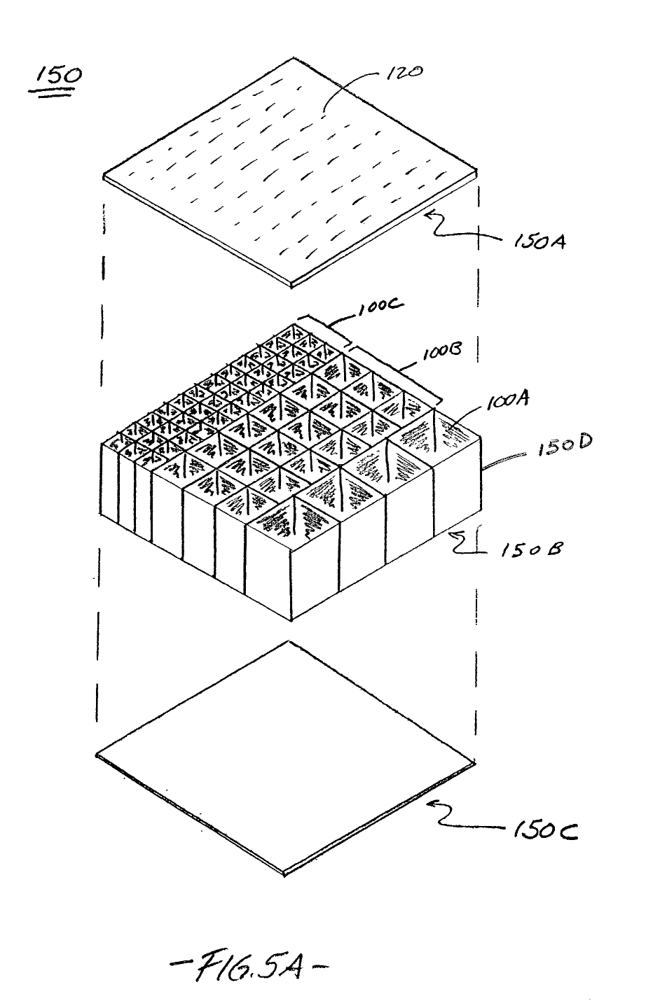

FIG. 4A shows a partial cutaway of a barrier 150 using various sizes of Helmholtz resonator cavities 100A, 100B and 100C, all in fluid communication with the external environment through apertures 120. The barrier 150 includes a face section 150A, core section 150B and base section 150C, the last of which can optionally be made of a thicker sheet of conventional metal, such as low carbon steel, to improve the TL of the Helmholtz resonator panel. This approach is ideal in situations where optimum absorption and TL is required without the addition of a separate concrete or block rear portion to the barrier. Other conventional materials, such as aluminum (and its alloys) are well-suited for the face and base sections 150A, 150C of the noise-suppressing barrier 150, while the central core section 150B can be made up of the aforementioned, or, in weight-sensitive applications, of lightweight plastics, composites or the like. In general, the walls of the core section 150B will be joined to both the face and base sections 150A and 150C, so that each of the cavities 100A, 100B and 100C will react independently to the noise-induced pressure fluctuations within the fluid medium. By using substantially rigid material for the cover, the base and the walls, the resulting cavities will have a rigidly fixed volume. This will help to minimize “mid-frequency” anomalies, flanking, and related phenomena. Selection of the preferred sizes of the cavities 100A, 100B and 100C in the core section 150B is based on typical highway noise spectral data. Assuming that a noise panel is to be designed for a highway application, sound in the range of about 125 Hz through 4,000 Hz would be the primary frequency range of offensive noise. Above 4,000 Hz, the TL of most noise barriers is more than ample, and the diffraction of sound over the top of the barrier is minimal. Maintaining a thin profile in the core section 150B of barrier 150 is much less critical than in cavity resonators used for duct-like structures (such as the aforementioned aircraft gas turbine engine inlet and exhaust ducts), where thick cavity structures have a significant impact on aircraft drag. In fact, other desirable structural criteria, such as increased ability to handle wind loading, can be realized by exploiting the higher moment of inertia inherent in a thicker panel structure.

An important additional consideration in the design of an outdoor noise barrier pertains to environmental effects on barrier durability and long-term acoustic performance. For example, moisture, in the form of rain, sleet or snow could, upon introduction to the barrier internals, clog up and reduce the effectiveness by changing the resonant frequency of Helmholtz cavities 100A, 100B and 100C, as well as destroy any added sound absorbing material (where present). One way to prevent the migration of water droplets into the barrier is to deviate the angle of incidence of the aperture slightly away from 90° relative to the top sheet, as shown with particularity in FIG. 4B. For example, an aperture that protrudes into the face at a slopingly upward angle of about 10° relative to the normal with the face would prevent rain penetration, even under high wind conditions.

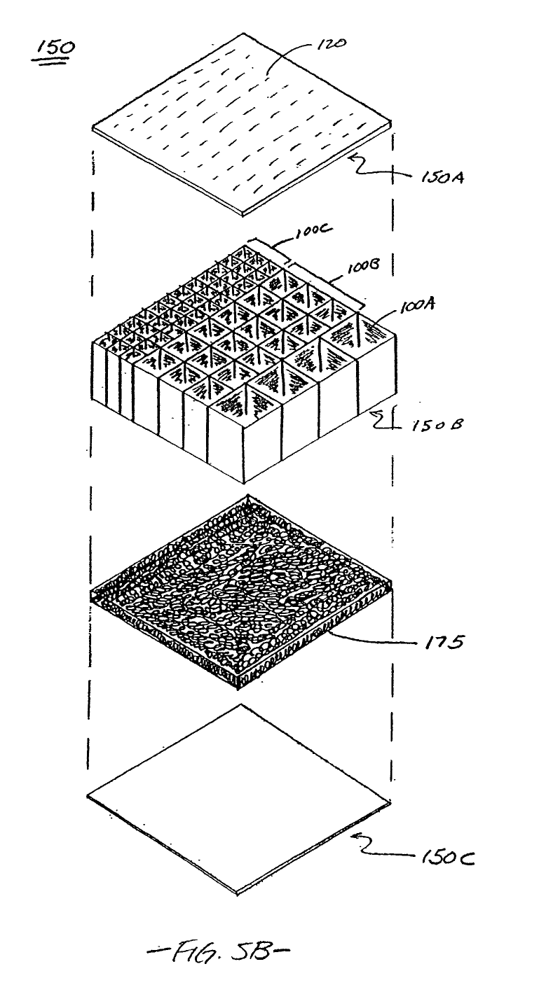

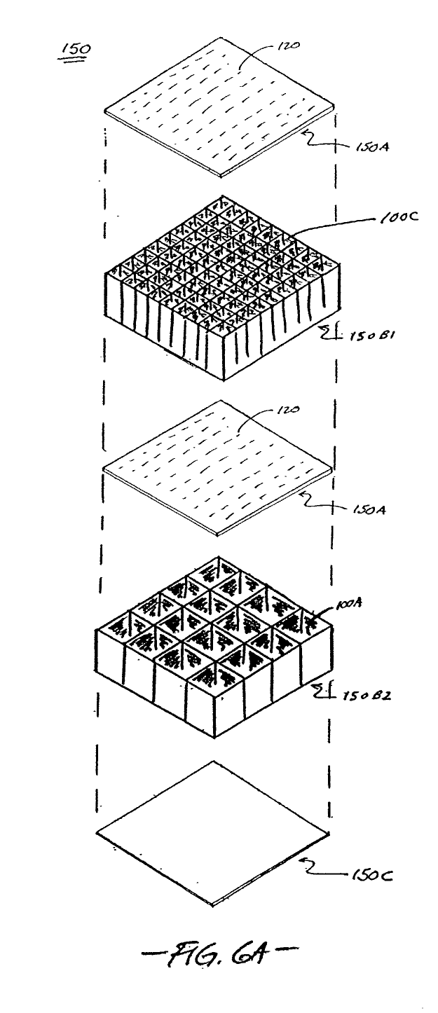

Referring particularly now to FIGS. 5A and 5B, an exploded view of a portion of broadband noise-suppressing panel 150 according to one aspect of the present invention is shown. As previously mentioned, the barrier 150 includes a face section 150A and base section 150C, with core section 150B sandwiched in between. Walls 150D of core section 150B extend from face section 150A to base section 150C. In the preferred embodiment, low frequency cavity 100A corresponds to a noise frequency of about 125 Hz, which is the predominant frequency of a diesel truck exhaust. The medium frequency cavity 100B corresponds to a higher noise frequency, while the high frequency cavity 100C corresponds to an even higher noise frequency. It will be appreciated by those skilled in the art that additional cavities tailored to a particular noise frequency can also be included, subject only to practical fabrication and cavity dimension to sonic wavelength limits. For example, a plurality of very high frequency cavities (not shown) that resonate at a noise frequency of 4000 Hz, which is predominantly due to certain types of tire noise of vehicles traveling at highway speeds, could be added for attenuation in and around that frequency. The different sized cavities can be made by conventional processes, such as the corrugation or expansion processes. In the corrugation process, sheets are stacked along their corrugation plateaus with an adhesive in between, which is then cured and cut to the desired thickness. In the expansion process, adhesive is added to stacked flat sheets in places where it is desired to have adjoining walls bonded, then the stack is cured then blown up with pressurized air, or stretched apart. As shown, the walls 150D have various orientations and they intersect one another at various locations. The thickness of any or all of face 150A, base 150C, or core 150B sections can be adjusted in alternate embodiments to accommodate a backing structural panel of concrete, block masonry, or the like. Additional separation distance between the face and base sections could be added to allow the insertion of a layer of conventional sound absorbing material. The addition of a relatively dense layer nearest the base section 150C will ensure that the cavity height and volume will not be changed, thus preserving the cavity's resonant frequency properties. FIG. 5B shows with particularity the addition of a layer of absorbing material 175 that is placed between the base and core sections 150C and 150B, respectively.

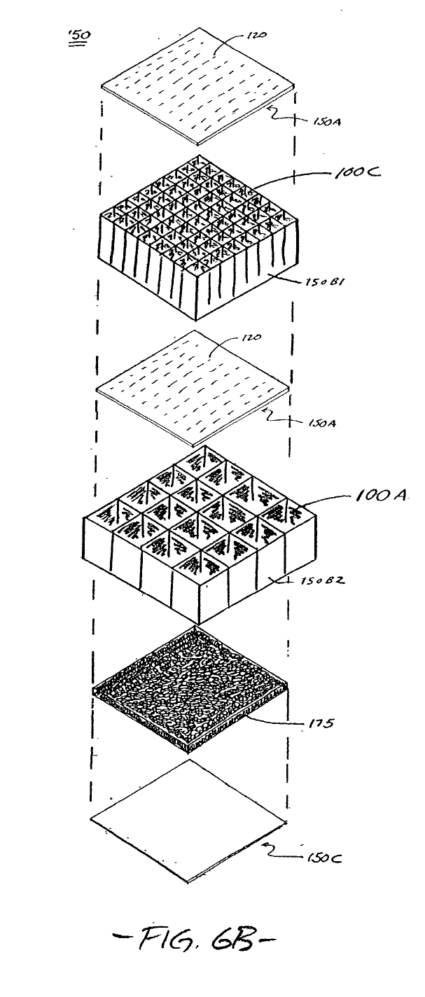

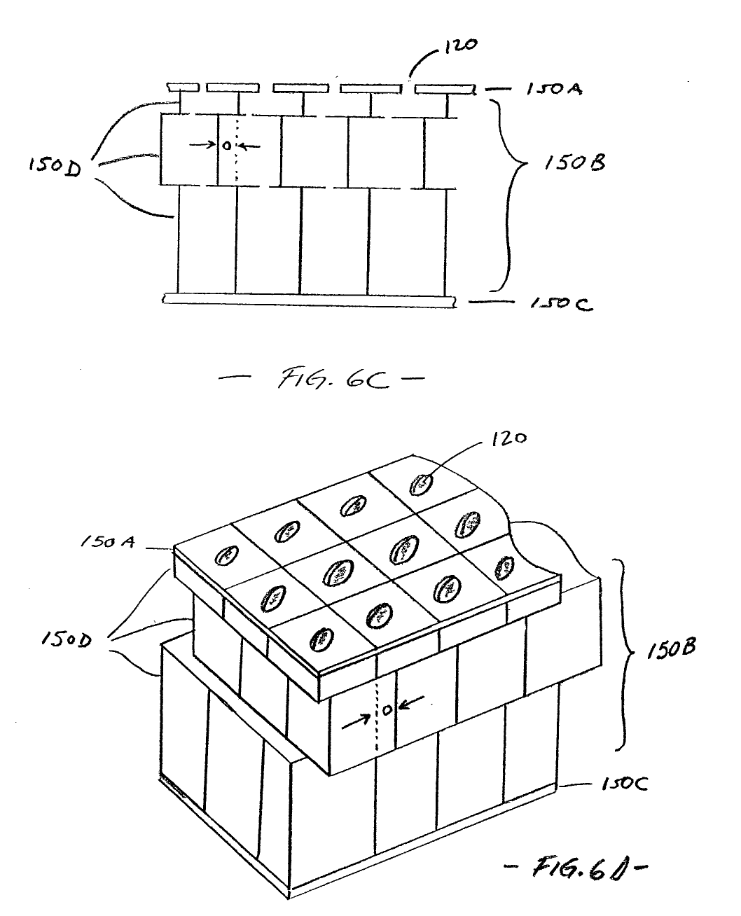

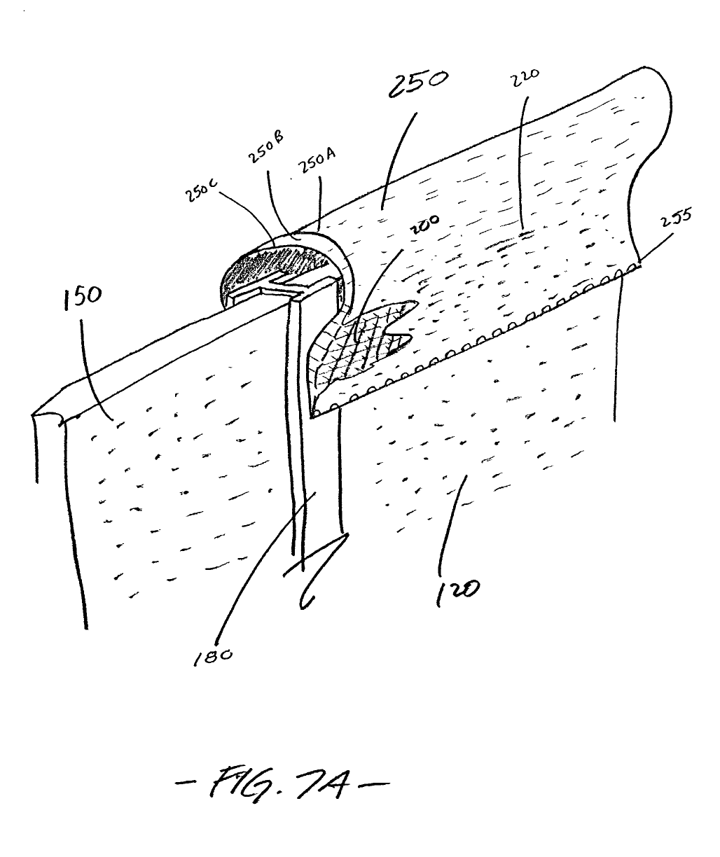

FIGS. 6A and 6B show an exploded view of a multilayer stack. This preferred embodiment of the invention may include a plurality of apertures disposed in the face sheet section, and, if present, in the interlayer spacers adjacent two layers. The apertures 120 may be either of a single diameter, or may be made up of apertures of with many different diameters, and may include a single or multiple apertures per cavity. While the embodiment shows a two-layer design with core section 150B including layered subsections 150B1 and 150B2, it will be appreciated by those skilled in the art that additional layers may be added and not detract from the spirit of the invention. Moreover, even though the two core layers are shown in the figures to be identical, it is also within the scope of this invention to have the two layers possessive of different cavity sizes between them to increase absorption bandwidth. In an alternate multilayer configuration, all of the cavities within a single layer can be of a single size (not shown), with frequency tuning coming predominantly (if not exclusively) from variations in the size and/or number of apertures disposed in the separating layers. This approach could be beneficial where cost is paramount, as the fabrication and tooling expense of creating myriad cavity sizes is abrogated.

Referring next to FIGS. 6C and 6D, the addition of different cavity configurations within the core section 150B can provide additional flanking reduction benefits, as the continuity of the transversely extending walls of the core section can be broken up. For example, by misaligning adjacent layers by offset O, where each layer may be of similar in-plane dimensions but different transverse dimensions to effect varying resonant frequency absorption peaks, a significant amount of the through-the-thickness structureborne modes of propagation can by decoupled, as most of the continuous paths from the noise source side of the barrier to the quieter side are eliminated.

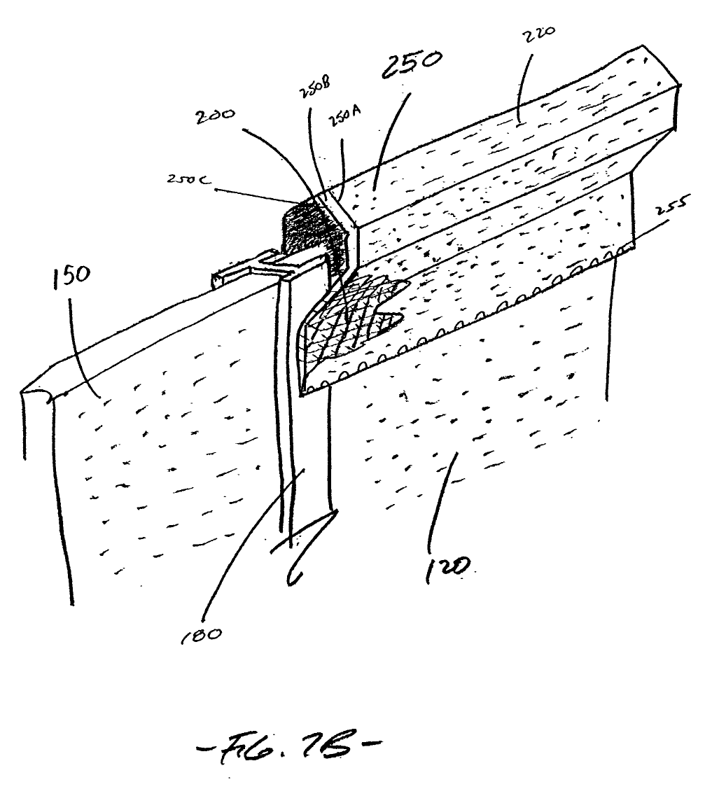

Referring now to FIGS. 7A and 7B, a diffraction cap 250 is shown mounted onto a section of barrier 150. The placement of the cap along a barrier edge, such as a top (as shown) or a lateral edge (at the ends of a barrier) is such that it includes at least one protruding barrier engagement piece 250A and an exaggerated bulbous piece 250B. Mounting and related attachment between the diffraction cap 250 and the panel of barrier 150 is preferably effected through the barrier engagement piece 250A, while the bulk of the diffraction absorptive treatment is situated in the bulbous piece 250B. Referring particularly to FIG. 7A, the diffraction cap 250 is of a generally curvilinear shape such that impinging acoustic noise (not shown) does not encounter sharp discontinuities in the cap, thus maximizing its diffraction performance. Construction of the diffraction cap 250 can be similar to that of the previous discussed barrier embodiments, in that it can be made up of a face section 250A, base section 250C, and one or more core sections 250B, made up of individual cavities 200. As before, it can be single layer or multilayered (not shown), and can include additional absorptive treatment (not shown), such as acoustic foams, fiberglass and related insulation materials. Apertures 220 in the face section (and in multilayer situations) interlayer sheets can permit the internal cavities to function as resonators, as with the previous embodiments. These apertures 220 can, in one configuration, be disposed only on vertical underlying face section surfaces (to avoid the inflow of moisture from rain or snow), or can be disposed over the entire diffraction cap surface. In the latter situation, provisions for the drainage of accumulated moisture could be accomplished through the inclusion of a drain 255 in the bottom. FIG. 7B shows a faceted approach to the diffraction cap 250, and can be used as an alternate to the curvilinear configuration of FIG. 7A.

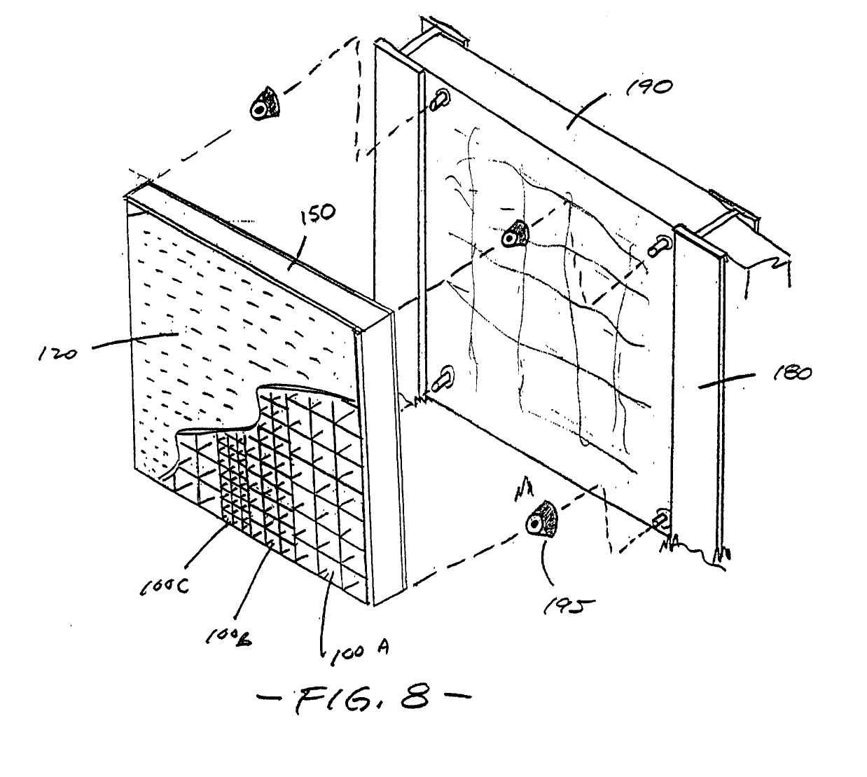

Referring now to FIG. 8, a noise suppressing panel according to another embodiment of the present invention is shown attached to an existing barrier 190. Conventional attachments 195 can be used to not only secure the panel to either the existing barrier 190 or the existing I-beams 180, but also to act as an acoustic isolation mount, thus minimizing structure borne noise propagation through the barrier.

The foregoing detailed description and preferred embodiments therein are being given by way of illustration and example only; additional variations in form or detail will readily suggest themselves to those skilled in the art without departing from the spirit of the invention. Accordingly, the scope of the invention should be understood to be limited only by the appended claims.

I claim:

1. A broadband noise barrier for use adjacent traffic flow, said barrier comprising:
a generally planar face section exposable to a source of acoustic disturbance, said face section including a plurality of apertures therethrough;
a base section spaced apart from said face section; and
a core section disposed between and coupled to said face section and said base section such that at least a portion of said core section is configured to be in fluid communication with said acoustic disturbance, said core section comprising a plurality of cavity sets each of which further comprises a plurality of resonator cavities tuned to preferentially absorb acoustic energy of a different frequency than the remaining cavity sets.

2. A broadband noise barrier according to claim 1, wherein said core section further comprises:
a plurality of layers in a stacked relationship such that each set of said plurality of cavity sets is disposed solely within a single layer of said plurality of layers; and
at least one perforate interlayer sheet disposed between adjacent layers of said plurality of layers to establish fluid communication therebetween.

3. A broadband noise barrier according to claim 2, wherein each resonator cavity is defined by a plurality of walls, said plurality of walls in each of said plurality of layers substantially misaligned along the transverse dimension of said barrier with walls of an adjacent layer.

4. A broadband noise barrier according to claim 2, wherein each successive layer of said plurality of layers in a stacked relationship is tuned to a successively higher frequency of said plurality of predetermined frequencies of said noise source than its immediately preceding layer.

5. A broadband noise barrier according to claim 1, further comprising sound absorbing material disposed within at least a portion of said resonator cavities.

6. A broadband noise barrier according to claim 1, wherein cavities from said plurality of cavity sets are interspersed among cavities from another set of said plurality of cavity sets to define a closely packed configuration.

7. A broadband noise barrier according to claim 1, further comprising a diffraction attenuator attached along at least a portion of at least one edge of said broadband noise barrier.

8. A broadband noise barrier configured for use along a roadway, said noise barrier comprising:
a face section substantially facing said roadway, said face section including a plurality of apertures therethrough;
a base section spaced apart from said face section; and
a core section disposed between and coupled to said face section and said base section such that at least a portion of said core section is configured to be in fluid communication with an acoustic disturbance coming from sources traversing said roadway, said core section comprising a plurality of resonator cavities of varying resonant frequency acoustic absorption characteristics.

9. A broadband noise barrier according to claim 8 wherein said plurality of resonator cavities are further defined by a plurality of cavity sets such that the physical dimensions each of said resonator cavities defined within a particular cavity set are similar, and that said physical dimensions of said resonator cavities within said particular cavity set are different than those of said resonator cavities within the remaining cavity sets.

10. A broadband noise barrier according to claim 8, wherein said core section further comprises:
a plurality of layers in a stacked relationship such that each set of said plurality of cavity sets is disposed solely within a single layer of said plurality of layers; and
at least one interlayer sheet disposed between adjacent layers of said plurality of layers, said at least one interlayer sheet defined by a plurality of interlayer apertures disposed therein such that said adjacent layers of said plurality of layers are in fluid communication with one another.

11. A broadband noise barrier according to claim 8, wherein said apertures extend through said face section in a slopingly upward path from the side of said face section exposable to said acoustic disturbance to the side of said face section disposed adjacent said core section.

12. A broadband noise barrier according to claim 8, wherein said plurality of apertures further comprise:
a first aperture set with at least one aperture of a first diameter; and
a second aperture set with at least one aperture of a second diameter different from said first diameter.

13. A broadband noise barrier according to claim 8, further comprising a diffraction attenuator attached along at least a portion of at least one edge of said noise barrier.

14. A broadband noise barrier according to claim 13, wherein said diffraction attenuator comprises a plurality of resonator cavities.

15. A broadband noise barrier configured for use along a traffic route, said noise barrier comprising:
a rigid structural backing member configured to be secured to a surface adjacent said traffic route; and
an acoustic panel member mountable to said rigid structural backing member, said acoustic panel member comprising:
a face section exposable to a source of acoustic disturbance, said face section including a plurality of apertures therethrough;
a base section spaced apart from said face section such that upon mounting of said acoustic panel member to said rigid structural backing member, said back side of said base section of said acoustic panel member is in facing relationship with said rigid structural member; and
a core section disposed between and coupled to said face section and said base section such that at least a portion of said core section is configured to be in fluid communication with said acoustic disturbance, said core section comprising a plurality of resonator cavities of varying resonant frequency acoustic absorption characteristics.

16. A broadband noise barrier according to claim 15, further comprising a diffraction attenuator attached along at least a portion of at least one edge of at least one of said rigid structural backing member or said acoustic panel member.

17. A broadband noise barrier according to claim 15, further comprising a vibration isolation mount configured to secure said rigid structural backing member to said acoustic panel member.

18. A method of reducing noise adjacent a traffic route comprising the steps of:
configuring a broadband noise barrier to comprise:
a face section exposable to a noise source, said face section including a plurality of apertures therethrough;
a base section spaced apart from said face section; and
a core section disposed between and coupled to said face section and said base section such that at least a portion of said core section is configured to be in fluid communication with said noise source, said core section comprising a plurality of resonator cavities of varying resonant frequency acoustic absorption characteristics tuned such that said resonator cavities are preferably responsive to a plurality of predetermined frequencies of said noise source;
arranging said noise barrier alongside at least a portion of said traffic route;
exposing said plurality of noise barriers to said noise source;
introducing said noise source into said core section; and
absorbing at least a portion of said noise corresponding to said plurality of predetermined frequencies with said plurality of resonator cavities.

19. A method according to claim 18, wherein said plurality of resonator cavities are further defined by a plurality of cavity sets such that the physical dimensions each of said plurality of resonator cavities defined within a particular cavity set are similar, and that said physical dimensions of said resonator cavities within said particular cavity set are different than those of said resonator cavities within the remaining cavity sets such that said core section further comprises:
a plurality of layers in a stacked relationship such that each set of said plurality of cavity sets is disposed solely within a single layer of said plurality of layers; and
at least one interlayer sheet disposed between adjacent layers of said plurality of layers, said at least one interlayer sheet defined by a plurality of interlayer apertures disposed therein such that said adjacent layers of said plurality of layers are in fluid communication with one another.

20. A method according to claim 19, wherein said step of introducing said noise source into said core section further comprises introducing successively higher frequencies of said plurality of predetermined frequencies of said noise source into each successive layer of said plurality of layers.

21. A method according to claim 19, wherein said step of configuring comprises arranging a plurality of walls in said core section to be substantially transverse to said face and base sections such that said plurality of walls are at least partially decoupled from walls in an adjacent layer.
